(19) United States
(12) Patent Application Publication
(10) Pub. No.: US 2026/0058501 A1
(43) Pub. Date: Feb. 26, 2026

(54) SYSTEM FOR INDUCTIVE ENERGY TRANSFER

(71) Applicant: MAHLE International GmbH, Stuttgart (DE)

(72) Inventors: Mike Boettigheimer, Kornwestheim (DE); Daniel Deischl, Nagold (DE); Rudolf Walter, Stuttgart (DE)

(21) Appl. No.: 19/104,203

(22) PCT Filed: Aug. 15, 2023
(86) PCT No.: PCT/EP2023/072483

§ 371 Date: Feb. 14, 2025

(30) Foreign Application Priority Data
Aug. 16, 2022 (DE) 102022120697.1

(51) Int. Cl. H02J 50/90; H02J 50/10; H02J 50/40

(52) U.S. Cl. CPC H02J 50/90; H02J 50/10; H02J 50/40

(57) ABSTRACT

A system for inductive energy transmission may include a stationary induction charging device, a mobile induction charging device, and a positioning device configured to detect a relative position of respective charging coils of the charging devices during charging. The positioning device may include a transmitting device and a receiving device that are each arranged in a respective one of the charging devices. The transmitting device may include at least two transmitters that simultaneously emit a respective transmission signal with an associated predetermined frequency. The receiving device may include a receiver configured to output a superimposition of all received transmission signals as a time-dependent received signal. The positioning device may be configured to i) determine an associated amplitude for each transmission signal from the time-dependent received signal and/or ii) provide a position information item from the determined amplitudes. The position information item may represent the relative position of the coils.

### CROSS-REFERENCE TO RELATED APPLICATIONS

This application claims priority to International Patent Application No. PCT/EP2023/072483, filed on Aug. 15, 2023, and German Patent Application No. DE 10 2022 120 697.1, filed on Aug. 16, 2022, the contents of both of which are hereby incorporated by reference in their entirety.

### TECHNICAL FIELD

The present invention relates to a system for inductive energy transfer comprising at least one stationary and at least one mobile induction charging device, with a positioning device determining the relative position of the induction charging devices inductively interacting with each other for inductive energy transfer. The invention also relates to a computer program product for the system.

### BACKGROUND

For inductive energy transmission, a stationary and a mobile induction charging device usually work together inductively in a system. The mobile induction charging device is usually located in an associated mobile application, for example in a motor vehicle, to enable inductive power transfer between the mobile application and the stationary induction charging device. For the transmission of energy, the respective induction charging device has an energy coil, wherein the energy coils couple with each other in a charging operation for inductive energy transmission. For this, the energy coils must be positioned in relation to each other appropriately. Increased efficiency of energy transmission can be achieved with more precise positioning of the energy coils in relation to each other.

### SUMMARY

The present invention is concerned with the task of specifying improved or at least different embodiments for a system of the type mentioned at the beginning, as well as for a computer program product for the system.

According to the invention, this task is solved by the subject matter of the independent claim(s). Advantageous embodiments are the scope of the dependent claim(s).

The present invention is based on the basic idea of using signals of different frequencies in a system for inductive power transmission to determine the relative position of associated energy coils, wherein the superposition of these signals is received and an associated amplitude for the respective received signal is determined from the superposition for the purpose of determining the relative position of the energy coils to one another. The use of at least two signals with a corresponding frequency allows a more precise determination of the relative position. At the same time, the processing of the superimposition of the signals to determine the amplitudes results in a simple implementation of a signal receiver, while still providing a reliable and accurate determination of the amplitudes of the signals relevant to determining the relative position.

In accordance with the inventive concept, the system has at least one stationary induction charging device and at least one mobile induction charging device. The respective mobile induction charging device is arranged in an associated mobile application, in particular in a motor vehicle. The respective induction charging device has a coil for inductive energy transmission, which will be referred to below as an energy coil. This means that the respective stationary induction charging device has a stationary energy coil and the respective mobile induction charging device has a mobile energy coil. The respective stationary induction charging device interacts with one of the at least one mobile induction charging devices in a charging operation in order to transfer energy inductively by means of the energy coils. A positioning device of the system is used to recognize the relative position of the energy coils belonging to the loading process in relation to each other. The positioning device has a transmitting device in one of the induction charging devices used for charging and a receiver in the other induction charging device. The transmitting device has at least two transmitters.

The respective transmitter emits a signal during operation at an associated, predetermined, and thus known frequency, wherein the frequencies of the transmitters are different. This means that the transmitters each output a transmission signal with an associated predetermined frequency at the same time. The receiving device has a receiver for receiving the transmission signals. The receiver is designed in such a way that the receiver outputs an overlay of all received transmission signals as a time-dependent signal. This signal is also referred to below as the received signal. The positioning device is also designed to determine the received signal from the received signal for the respective received transmission signal, an associated amplitude. In addition, the positioning device is designed in such a way that it generates position information from the determined amplitudes, which represents a relative position of the energy coils to one another.

The position information is advantageously provided to an assistance device, in particular a driving assistance device, in order to achieve a relative movement of the mobile induction charging device, in particular of the mobile application, to the stationary induction charging device, which leads to an optimization in the inductive energy transmission and thus to an optimal positioning of the energy coils to each other. This can be done, for example, via a human-machine interface, also known by the English abbreviation “HMI,” in order to provide a mobile application operator, in particular a vehicle driver, with appropriate recommendations. Alternatively or additionally, the assistance system can move the mobile application, in particular drive it, at least semi-autonomously, taking into account the position information.

During charging, the inductively interacting energy coils are arranged opposite each other and at a distance from each other in a direction, which will also be referred to as the first direction below. The first direction corresponds to the Z-direction of the motor vehicle as a mobile application.

The system may include a single stationary induction charging device.

The system can also have two or more stationary induction charging devices. For example, the system can have a dedicated stationary induction charging device for at least two different parking areas in a parking lot, for example in a parking garage.

The system may include a single mobile induction charging device.

The system can also have two or more mobile induction charging devices. In this case, the respective mobile induction charging device is advantageously part of an associated mobile application. This means, for example, that the system can have at least two mobile induction charging devices, with each mobile induction charging device being part of an associated motor vehicle.

The respective stationary induction charging device is capable of interacting inductively with the respective at least one mobile induction charging device for inductive energy transmission. This means that the respective stationary induction charging device interacts inductively with one of the at least one mobile induction charging devices in a charging operation for inductive energy transfer.

When charging, one of the energy coils acts as the primary coil and the other energy coil as the secondary coil. This means that bidirectional, inductive energy transmission is also possible.

The position information is used to achieve improved and simplified positioning of the energy coils in relation to each other perpendicular to the first direction, in particular by means of the assistant device. This means that the position information is used to improve and simplify the positioning of the energy coils in relation to one another in a second direction running transverse to the first direction and in a third direction running transverse to the first and second directions. In the case of a motor vehicle as a mobile application, the second direction and the third direction correspond to the X-direction and the Y-direction of the motor vehicle.

As explained above, the received signal corresponds to the superimposition of all transmission signals received. The received signal is time-dependent and can therefore change over time.

The positioning device can determine the amplitudes associated with the received signals from the received signal in any way, that is, in particular by means of any processes/methods.

In preferred embodiments, the positioning device is designed to demodulate the received signal using IQ demodulation and thus determine an associated amplitude for the respective received transmission signal from the received signal.

In IQ demodulation, at least one so-called I-value and at least one so-called Q-value are extracted from the received signal for the respective frequency and thus for the respective transmission signal. The following applies to the amplitude A of the respective transmission signal:

$$A = \sqrt{( {I}^{2} + {Q}^{2} )}$$

Alternatively or additionally, the positioning device can be designed to determine an associated amplitude for the respective received transmission signal from the received signal by means of a Fourier transform. Preferably, this is done using the Fast Fourier Transform, also known as the “Fast Fourier Transformation” and abbreviated as “FFT.”

Alternatively or in addition, the positioning device can be designed to determine an associated amplitude from the received signal by means of a filter with a finite impulse response for the respective received transmission signal. A finite impulse response filter is also commonly called a “finite impulse response filter” and the abbreviation “FIR”.

When using a finite impulse response filter, a segmented correlation and/or convolution is preferably used. This means that the positioning device is designed to determine an associated amplitude for the respective received transmission signal from the received signal by means of section-by-section correlation and/or by means of convolution.

It is advantageous to use a rectangular window with a finite impulse response filter that corresponds to the frequency spectrum of the frequency range of interest, in particular the IQ demodulation. The positioning device is designed accordingly.

A cosine-roll off window is preferred for filters with a finite impulse response. The positioning device is designed accordingly. This has the advantage that side lobes in the frequency spectrum, especially with IQ demodulation, are attenuated and thus a significant reduction in interference sensitivity is achieved.

The following is mainly concerned with IQ demodulation. However, it is clear that the explanations, and in particular the components described, can be applied accordingly to other implementations for determining the amplitudes.

The receiver scans the received signal with sampling rates that are matched to the frequencies of the transmission signals. This means that the receiver is designed in such a way that it samples the received signal sequentially at sampling rates that correspond to a multiple integer of the frequency of the respective transmission signal. The sampled values are used to determine the amplitude associated with the respective transmission signal. The received signal is sampled at a multiple of the frequency of one of the transmission signals and the amplitude associated with the transmission signal is determined on the basis of the values thus obtained. The received signal is then sampled with a multiple integer of the frequency of another of the transmission signals and the amplitude associated with the transmission signal is determined on the basis of the values thus obtained, etc. This results in an accurate determination of the I and Q values and, consequently, an accurate determination of the amplitudes.

In preferred embodiments, the receiving device is designed to sample the received signal sequentially at sample rates corresponding to four times the frequency of the respective transmission signal. The sampling rate for the respective transmission signal is therefore four times the frequency of the transmission signal. Thus, with IQ demodulation, two I values and two Q values are determined, for example I at 0°, Q at 90°, −I at 180°, and −Q at 270°. In particular, knowledge of the phase of the received signal is not required in this way. This leads to a simple and resource-efficient determination of the amplitudes and thus to a simple and resource-efficient determination of the position information.

Several I-values and Q-values, in particular several hundred I-values and Q-values, are determined for the respective sampling rate and thus for the respective transmission signal, and these are averaged. The amplitudes are determined by means of the mean values. The positioning device is designed accordingly. In addition to the simple and resource-saving determination of the amplitudes, this leads to an increase in selectivity and thus to a reliable determination of the position information.

It is also conceivable to sample the received signal with so-called “undersampling.” The distance t between I, Q, −I, and −Q for a given frequency continues to be a multiple, in particular four times, the frequency. The time between two I-values or Q-values can, however, be a multiple of the frequency period. Likewise, I, Q, −I, and −Q can be sampled in a staggered manner. For example, the following applies to the distance t between the sampling times for I and Q: t_Q_n=t_I_n+360°+90°.

In preferred embodiments, the receiving device has an analog-to-digital converter, also known as an ADC, connected downstream of the receiver to sample the received signal and/or determine the respective amplitude and a microcontroller, in particular a digital signal processor, also known by the English abbreviation “DSP,” connected to the analog-digital converter for data transfer. In this process, the microcontroller, in particular the digital signal processor, sets the analog-to-digital converter to the sampling rates one after the other. The respective sampling rate is therefore the clock rate of the analog-digital converter, which is set by the microcontroller, in particular by the digital signal processor, for the respective transmission signal in succession. The analog-digital converter transmits the sampled values, i.e., the I-values and the Q-values, to the microcontroller, in particular to the digital signal processor, wherein the microcontroller, in particular the digital signal processor, determines the amplitudes associated with the transmission signals from the sampled values one after the other. The reception area is designed accordingly. This is based on the knowledge that the amplitude A for a certain frequency always corresponds to the square root of the square sums of the I-value and the Q-value, i.e.,

$$A = \sqrt{( {I}^{2} + {Q}^{2} )}$$

regardless of the phases. As explained above, this eliminates the need to consider phases and thus, in particular, the use of mixers. Accordingly, the amplitudes are determined with less hardware effort and thus also more cost-effectively, provided that the selectivity is sufficiently high. This leads to a precise determination of the amplitudes and thus the position information at reduced costs.

Preferred embodiments are those in which the receiving device is designed in such a way that it determines an offset of the received signal from two values, offset by 180°, of at least one of the sampling rates, advantageously the respective sampling rate, and takes this into account when determining the amplitudes. The offset is to be taken into account in such a way that the received signal lies within the operating parameters of the analog-digital converter. The offset is directly determined in a simplified manner during the determination described above, for example of Q and −Q or I and −I.

It is advantageous to condition the received signal before sending the received signal to the analog-digital converter. This may include, in particular, the aforementioned consideration of the offset. Likewise, the conditioning may include amplification of the received signal.

Alternatively or additionally, advantageously alternatively, the receiving device can comprise at least one mixer, wherein the at least one mixer mixes the received signal for the respective frequency offset by 90° in order to provide corresponding I-values and Q-values.

In preferred embodiments, the receiving device has two mixers connected downstream of the receiver and an analog-to-digital converter connected downstream of the mixers, as well as a local oscillator connected to the mixers and a microcontroller. The microcontroller is connected to the analog-digital converter and to the local oscillator. The received signal is transmitted to the mixers. The received signal can be conditioned beforehand. The microcontroller uses the local oscillator to set the frequency associated with the respective transmission signal at the mixers one after the other, so that the mixers mix the received signal at 90° to each other and provide the analog-digital converter. The analog-digital converter provides the converted signal to the microcontroller, wherein the microcontroller determines the amplitudes associated with the transmission signals from the converted signal one after the other. The reception area is designed accordingly.

It is advantageous to place a low-pass filter between the respective mixer and the analog-digital converter.

Alternatively, it is conceivable to use a separate switching group of mixers and analog-digital converters for each frequency, possibly with low-pass filters. This means that the amplitudes can be determined simultaneously.

In principle, the receiver can be designed in any way.

The receiver advantageously has at least one coil for receiving the transmission signals.

Preferably, the receiver has two offset windings, hereinafter also referred to as receiving coils, which receive the transmission signals and output the received signal. The receiving coils are wound in particular at right angles to each other, i.e., offset at 90° to each other.

The receiving device preferably has a single such receiver. This results in a compact design and cost-effective production of the receiving device.

In principle, the respective transmitter can generate the associated transmission signal with any associated and predetermined frequency.

The transmitters advantageously generate the associated transmission signal with a frequency in the kilohertz range.

The preferred frequency of the respective transmitter is between 110 kHz and 148.5 kHz.

The frequencies of the transmitters are advantageously spaced by at least 0.5 kHz.

The transmitting device advantageously has at least two transmitters spaced apart transversely to the first direction for determining the relative position of the energy coils to one another in the area close to the stationary energy coil, which transmitters are hereinafter also referred to as close-range transmitters. The respective close-range transmitter thus generates an associated transmission signal with an associated, predetermined frequency during operation. The received signal includes the superposition of at least the two transmission signals when positioned correctly relative to the close-range transmitters.

The area near the stationary energy coil is advantageously the area with a distance of up to 0.5 m from the stationary induction charging device, running transverse to the first direction.

Preferably, the respective close-range transmitter generates a magnetic field with a main axis along the first direction as the transmission signal.

The transmitting device advantageously has a transmitter for determining the relative position of the energy coils to one another in the area further away from the stationary energy coil, which is also referred to below as the remote transmitter. The remote transmitter thus generates an associated transmission signal with an associated, predetermined frequency during operation.

The area further away from the stationary energy coil is advantageously the area with a distance of more than 0.5 m, in particular more than 1.5 m, from the stationary induction charging device, running transverse to the first direction.

Preferably, the remote transmitter in operation generates a magnetic field with a main inclined or transverse to the first direction as a transmission signal.

In principle, the transmitting device can be located in the mobile induction charging device and the receiving device in the stationary induction charging device. It is useful if the respective mobile induction charging device has a transmitter of this kind and the respective stationary induction charging device has a receiver of this kind.

In preferred embodiments, the transmitting device is arranged in the stationary induction charging device and the receiving device is arranged in the mobile induction charging device. This results in lower latency when determining position information and in particular in the assistance system.

It is useful if the stationary induction charging device has a transmitter and the mobile induction charging device has a receiver.

If the system has two or more transmitting devices, in particular two or more stationary induction charging devices, each with a transmitting device, the remote transmitters of neighboring transmitting devices preferably have different, predetermined frequencies.

A computer program product is preferably used to determine the amplitudes and generate the position information.

The computer program product includes instructions that, when the computer program product is executed by the positioning device, cause the positioning device to determine the amplitudes and generate the position information.

The computer program product is stored on a non-volatile memory. The computer program product is advantageously stored at least in part, preferably entirely, in the positioning device, in particular in the receiving device.

Further important features and advantages of the invention are apparent from the dependent claims, from the drawings, and from the associated description of the figures with reference to the drawings.

It is understood that the above-mentioned features and those yet to be explained below can be used not only in the combination indicated in each case, but also in other combinations or on their own, without deviating from the scope of the present invention.

Preferred exemplary embodiments of the invention are shown in the drawings by way of example and will be explained in more detail in the following description, wherein identical reference signs refer to identical or similar or functionally identical elements.

### BRIEF DESCRIPTION OF THE DRAWINGS

It shows, schematically in each case

FIG. 1 shows a highly simplified, circuit-like representation of a system for inductive energy transmission in a charging operation of two induction charging devices,

FIG. 2 shows a simplified plan view of an induction charging device with a transmitter of a positioning device of the system,

FIG. 3 shows diagrams with transmission signals from transmitters of the transmission device,

FIG. 4 shows a plan view of a receiver of a receiving device of the positioning device,

FIG. 5 shows a received signal of the receiver,

FIG. 6 shows a schematic diagram of the receiver device, and

FIG. 7 shows a schematic diagram of the receiver device in another exemplary embodiment.

### DETAILED DESCRIPTION

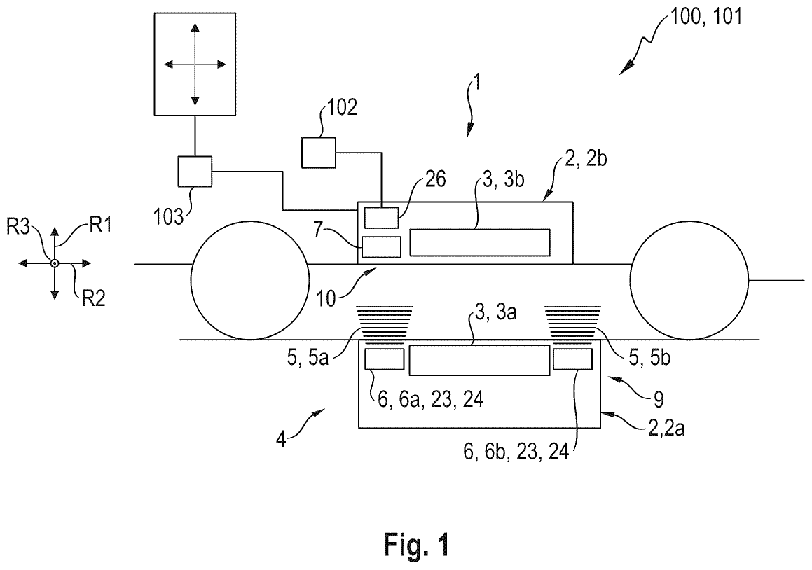

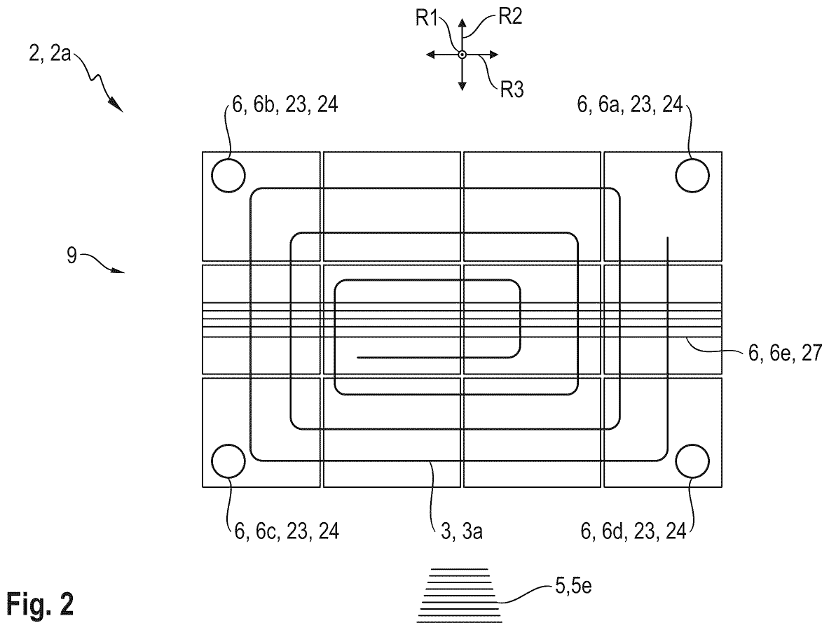

A system 1, exemplified in FIGS. 1 through 7, is used for inductive energy transmission. According to FIG. 1, the system 1 has at least two induction charging devices 2 for this purpose, namely at least one stationary induction charging device 2, 2a and at least one mobile induction charging device 2, 2b. In a charging operation as indicated in FIG. 1, the respective stationary induction charging device 2, 2a can interact inductively with one of the at least one mobile induction charging devices 2, 2b for inductive energy transfer. In charging mode, the respective stationary induction charging device 2 can thus be a charging point of system 1. For inductive energy transmission, the respective induction charging device 2, as shown in FIG. 1 in particular, has a coil 3, which will also be referred to below as an energy coil 3. Thus, the respective stationary induction charging device 2, 2a has a stationary energy coil 3, 3a (see also FIG. 2) and the respective mobile induction charging device 2, 2b has a mobile energy coil 3, 3b. One of the energy coils 3 serves as a primary coil during charging, which generates an alternating magnetic field that induces a voltage in the other energy coil 3, which serves as a secondary coil, for energy transmission. As indicated in FIG. 1, in charging mode the induction charging devices 2, in particular the energy coils 3 of the induction charging devices 2, which cooperate for inductive energy transfer, are arranged at a distance from each other and opposite each other in a direction R1, which is also referred to below as the first direction R1. This induction charging device 2 and its energy coils 3 are also referred to below as “associated”. The respective mobile induction charging device 2, 2b is provided in an associated mobile application 100. In the exemplary embodiments shown, the application 100 is a motor vehicle 101. The first direction R1 runs along, in particular parallel to, the Z-direction of the motor vehicle 101. The first direction R1 therefore corresponds in particular to a height direction. In addition, in order to enable charging and to achieve a high level of efficiency during charging, the associated energy coils 3 are positioned relative to one another at right angles to the first direction R1, i.e., in a second direction R2 running at right angles to the first direction R1, and in a third direction R3 running at right angles to the first direction R1 and the second direction R2. In this position, the associated energy coils 3 preferably overlap at least partially in the second direction R2 and in the third direction R3. In the second direction R2, the exemplary embodiments shown are the direction of travel of the mobile application 100 or the motor vehicle 101, i.e., the X-direction of the motor vehicle 101. As shown in FIG. 1, energy can be transferred inductively to the mobile induction charging device 2, 2b, in particular, in order to charge a battery 102 of the mobile application 100. For this purpose, a rectifier 26 can be provided between the mobile energy coil 3, 3b and the battery 102, which converts the voltage induced in the mobile energy coil 3, 3b into a rectified voltage. In the exemplary embodiment shown, the rectifier 26 is purely by way of example part of the mobile induction charging device 2, 2b. The inductive energy transfer can also be carried out from the mobile induction charging device 2, 2b to the stationary induction charging device 2, 2a, and thus in principle also bidirectionally.

A positioning device 4 of the system 1 is used to detect the relative position of the energy coils 3 belonging to the charging process and thus the induction charging devices 2 to each other. This can be used as part of a driving assistance system to position the mobile application 100, in particular the motor vehicle 101, appropriately in relation to the stationary induction charging device 2, 2a. For this purpose, the positioning device 4 generates two signals 5 in one of the induction charging devices 2 that interact during the charging process, i.e., in one of the associated induction charging devices 2. The signals 5 are also referred to below as transmission signals 5. The transmission signals 5 are received in the other induction charging device 2. For this purpose, the positioning device 4 has a transmitting device 9 in one of the induction charging devices 2 and a receiving device 10 in the other induction charging device 2. The transmission signals 5 are generated by the transmitting device 9 and received by the receiving device 10. In the exemplary embodiments shown, the transmitting device 9 is part of the stationary induction charging device 2, 2a and the receiving device 10 is part of the mobile induction charging device 2, 2b. The respective stationary induction charging device 2, 2a thus has a transmitting device 9 and the respective mobile induction charging device 2, 2b has a receiving device 10.

As can be seen from FIGS. 1 and 2, the transmitting device 6 has an associated transmitter 6, i.e., at least two transmitters 6, to generate the respective transmission signal 5. During operation, the respective transmitter 6 generates the associated transmission signal 5 with an associated predetermined frequency f and outputs the transmission signal 5, with the transmitters 6 generating and outputting the respective associated transmission signal 5 simultaneously. During operation, the transmitters 6 therefore each simultaneously emit a transmission signal 5 with an associated predetermined frequency f, wherein the frequencies f of the transmitters 6 differ from one another. In the exemplary embodiments shown, a magnetic field is generated as a transmission signal 5 using the respective transmitter 6. The frequency f of the respective transmitter 6 and thus the transmission signal 5 is between 110 kHz and 148.5 kHz. The frequencies f are favorably between 134.0 kHz and 137.0 kHz and 0.5 kHz apart.

As can be seen from FIG. 2, the transmitting device 5 in the illustrated exemplary embodiments has four transmitters 6, i.e., a first transmitter 6, 6a, a second transmitter 6, 6b, a third transmitter 6, 6c, and a fourth transmitter 6, 6d. The transmitters 6 are arranged in the corners of an imaginary square (not shown) in the plan view shown in FIG. 2, with the square framing the energy coil 3 of the associated induction charging device 2, in the illustrated exemplary embodiments thus the stationary induction charging device 2, 2a in the plan view.

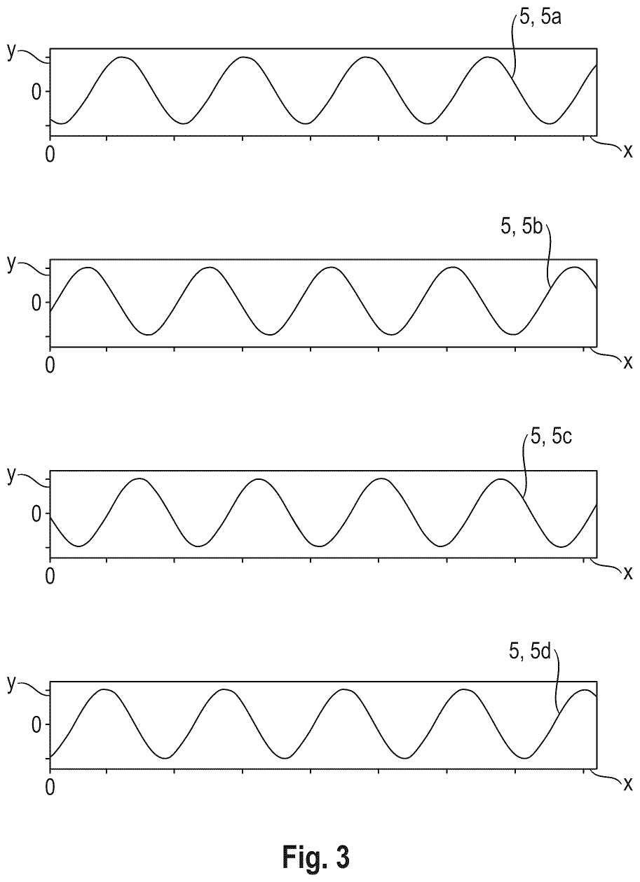

FIG. 3 shows diagrams with the transmission signals 5 of the transmitters 6, where the temporal course is plotted along the respective abscissa axis X and the strength is plotted along the respective ordinate axis Y in FIG. 3. As can be seen in FIG. 3, the first transmitter 6, 6a transmits a first transmission signal 5, 5a with a first frequency f, f1, the second transmitter 6, 6b transmits a second transmission signal 5, 5b with a second frequency f, f2, the third transmitter 6, 6c transmits a third signal 5, 5c with a third frequency f, f3, and the fourth transmitter 6, 6d transmits a fourth transmission signal 5, 5d with a fourth frequency f, f4. At least two of the transmitters 6, preferably all of the transmitters 6, output the associated transmission signals 5 at the same time. As can also be seen in FIG. 3, the transmission signals 5 are output with the same strength but different frequencies f. For example, the first frequency f1 is 111.5 kHz, the second frequency f2 is 112.0 kHz, the third frequency f3 is 113.0 kHz, and the fourth frequency f4 is 113.5 kHz.

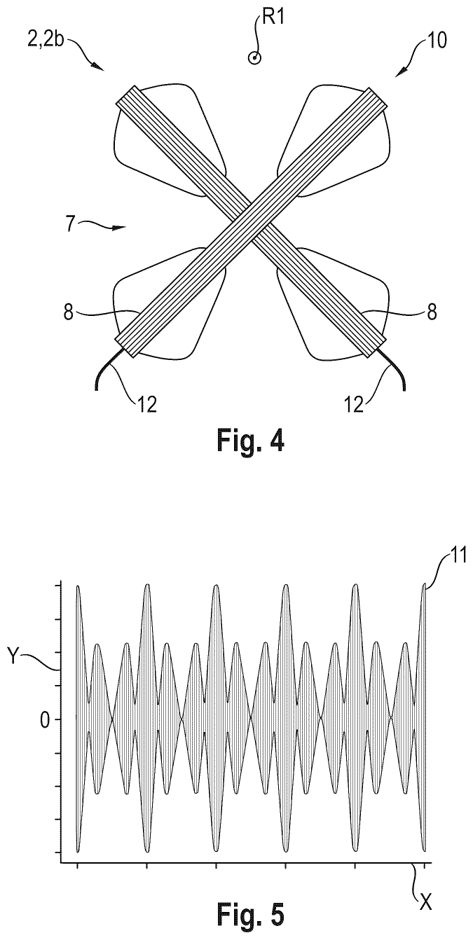

The receiving device 10 has, as can be seen for example from FIG. 4, a receiver 7 for receiving the transmission signals 5. In the exemplary embodiments shown, the receiving device 10 has a single receiver 7. As can be seen in FIG. 4, the receiver 7 in the illustrated exemplary embodiments has two receiving coils 8, which are wound offset to each other by 90°. The signal 11 received by the receiving coil 8 is shown in FIG. 5 as an example and corresponds to a superimposition of all transmission signals 5 received. The received signal 11 is also referred to below as received signal 11. The received signal 11 is thus time-dependent. The received signal 11 can be tapped at the receiver 7, as indicated in FIG. 4 with electrical connections 12. The receiver 7 thus emits the received signal 11, wherein the received signal 11 is present in the form of an electrical voltage. Accordingly, FIG. 5 shows the temporal course along the abscissa axis X and the voltage course of the received signal 11 along the ordinate axis Y.

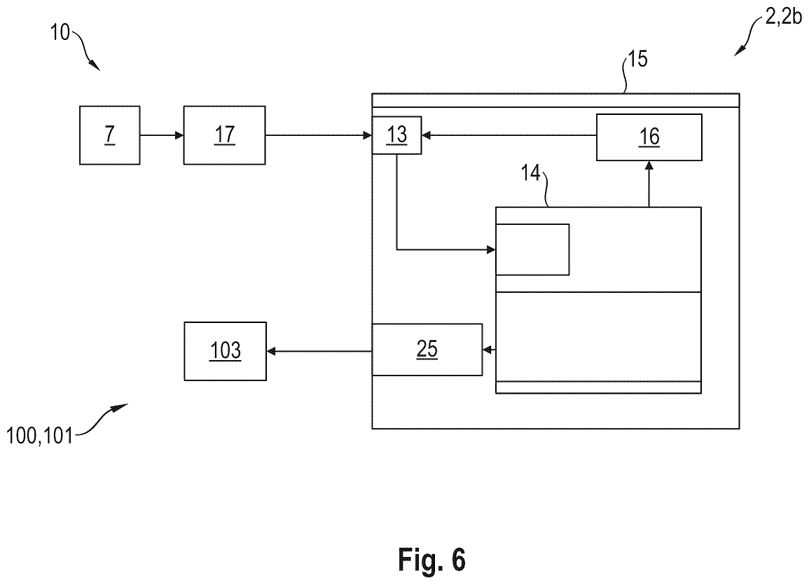

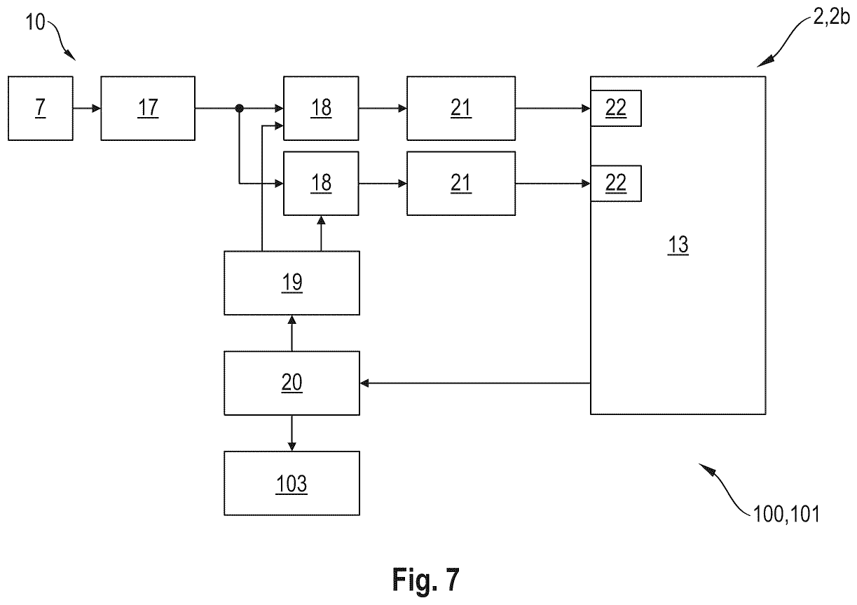

As explained below, in particular with reference to FIGS. 6 and 7, the positioning device 4 is designed to determine an associated amplitude A from the received signal 11 for the respective received transmission signal 5. The respective amplitude A represents the strength of the associated transmission signal 5 at the location of the receiver 7, i.e., the local strength of the associated transmission signal 5. In addition, the positioning device 4 is designed in such a way that it generates position information from the determined amplitudes A, which represents a relative position of the energy coils 3 to one another.

The amplitudes A from the received signal 11 can be determined, for example, by means of a Fourier transform, preferably by means of a fast Fourier transform, also known under the name fast Fourier transformation and the abbreviation “FFT.” Alternatively, or in addition, the amplitudes A can be determined from the received signal 11 using a filter with a finite impulse response, also known as a finite impulse response filter and abbreviated as “FIR.” Advantageously, a section-by-section correlation and/or convolution is used. The design of the positioning device 4 is based on this.

In the exemplary embodiments described below, the amplitudes A are determined using IQ stimulation. However, it is understood that the following description is similarly applicable to the methods mentioned above.

In the exemplary embodiments shown, the positioning device 4 is designed in such a way that it demodulates the received signal 11 by means of IQ demodulation and thus determines an associated amplitude A for the respective received transmission signal 5 from the received signal 11. The respective amplitude A represents the strength of the associated transmission signal 5 at the location of the receiver 7, i.e., the local strength of the associated transmission signal 5. In addition, the positioning device 4 is designed in such a way that it generates position information from the determined amplitudes A, which represents a relative position of the energy coils 3 to one another.

In the exemplary embodiment shown in FIG. 6, the amplitudes A of the transmission signals 5 are determined from the received signal 11 by sampling the received signal 11. To determine the amplitude A of the respective transmission signal 5 from the received signal 11, the received signal 11 is sampled at a sampling rate which corresponds to a multiple G of the frequency f of the transmission signal 5, in the illustrated exemplary embodiment, four times the frequency. To determine the amplitude A, A1 of the first transmission signal 5, 5a, a sampling rate is selected that corresponds to four times the first frequency f, f1. To determine the amplitude A, A2 of the second transmission signal 5, 5b, a sampling rate is therefore selected which corresponds to four times the second frequency f, f2. To determine the amplitude A, A3 of the third transmission signal 5, 5c, a sampling rate is selected that corresponds to four times the third frequency f, f3. To determine the amplitude A, A4 of the fourth transmission signal 5, 5d, a sampling rate is selected that corresponds to four times the fourth frequency f, f4. Thus, for the respective sampling rate, there are four sampling points at 0°, 90°, 180°, and 270° with respect to the period of the frequency f. The respective sampling time provides a value, where the values determined offset by 90° correspond in amount to the I-values or Q-values of the IQ demodulation. In other words, the value at the sampling point 0° corresponds to I, the value at the sampling point 90° corresponds to Q, the value at the sampling point 180° corresponds to −I, and the value at the sampling point 270° corresponds to −Q. The value at the sampling point 360° corresponds again to the value I, etc. With the knowledge that the amplitude A of a transmission signal 5 of a given frequency f always corresponds to the square root of the squares of the sums of I and Q of this frequency f, i.e.,

$$A = \sqrt{( {I}^{2} + {Q}^{2} )}$$

the associated amplitude A can thus be determined from the received signal 11 for the respective transmission signal 5 in a simple and reliable manner, wherein possible phases do not need to be taken into account.

In the example discussed, an associated amplitude A, i.e., a total of four amplitudes A, is thus determined for the respective transmission signal 5. To improve the selectivity, several I-values and Q-values, in particular several hundred I-values and Q-values, can be determined for the respective sampling rate and thus for the respective transmission signal 5, and these can be averaged. It is also conceivable to average the absolute values of I and −I as well as Q and −Q.

In the exemplary embodiment shown in FIG. 6, the receiving device 10 has an analog-digital converter 13 connected downstream of the receiver 7 and a digital signal processor 14 connected to the analog-digital converter 13 in a data-transmitting manner. The analog-to-digital converter 13 is also known by the English abbreviation “ADC” and the digital signal processor 14 by the English abbreviation “DSP.” During operation, the digital signal processor 14 sets the analog-to-digital converter 13 to the sampling rates one after the other. In the illustrated exemplary embodiments, this is done via a trigger source 16, which may, for example, comprise a PWM generator that is not shown. The sampling rate set on analog-digital converter 13 therefore corresponds to the current clocking of analog-digital converter 13. The analogue-to-digital converter 13 transmits the sampled values to the digital signal processor 14, i.e., the values for I, Q, −I, and −Q as described above. The digital signal processor 14 uses the sampled values to determine the amplitude A associated with the sampling rate. This means that the received signal 11 can be sampled successively at the sampling rates of the respective frequency f and thus the associated amplitude A can be determined successively from the received signal 11 for the respective transmission signal 5. This means that the amplitudes A associated with the transmission signals 5 are determined one after the other.

As shown in FIG. 6, the analog-digital converter 13 and the digital signal processor 14 can be combined in a microcontroller 15, which is also referred to below as a DSP microcontroller 15. In the exemplary embodiment shown, the DSP microcontroller 15 also comprises the trigger source 16.

As can be seen in FIG. 6, a conditioning 17 of the received signal 11, indicated by a box, takes place between the receiver 7 and the analog-to-digital converter 13. The conditioning 17 includes taking into account an offset of the received signal 11, which is present as a voltage. For this purpose, the offset is determined from two values offset by 180° for at least one of the sampling rates, in particular for the respective sampling rate. This means that the offset is determined from the values for I and −I, for example, or from the values for Q and −Q. The conditioning 17 may also include amplification of the received signal 11. The offset can be determined in the digital signal processor 14.

In the exemplary embodiment shown in FIG. 7, the receiving device 10 has two mixers 18 connected downstream of the receiver 7, an analog-to-digital converter 13 connected downstream of the mixers 18, a local oscillator 19 connected to the mixers 18, and a microcontroller 20. The microcontroller 20 is connected to the analog-digital converter 13 and to the local oscillator 19. The received signal 11 is transmitted to the mixers 18. In the exemplary embodiment shown, the received signal 11 is transmitted to the mixers 18 after conditioning 17, for example after signal amplification. To determine the amplitude A of a transmission signal 5, the microcontroller 20 uses the local oscillator 19 to set the frequency f associated with the transmission signal 5 at the mixers 18 in such a way that the mixers 18 mix the received signal at 90° to each other. This is known as the “I&Q method.” The mixed signal is provided to analog-digital converter 13. In the exemplary embodiments shown, a low-pass filter 21 is arranged between the respective mixer 18 and the analog-digital converter 13. In addition, the analog-digital converter 13 has associated inputs 22 for the respective mixer 18 and thus for the respective low-pass filter 21. Consequently, the I values required for the IQ demodulation reach the analog-digital converter 13 via one of the inputs 22, and the Q values required for the IQ demodulation reach the analog-digital converter 13 via the other input 22. Thus, the microcontroller 20 can determine the amplitude A of the transmission signal 5 at the set frequency f from the data provided by the analog-to-digital converter 13 in accordance with the above rule. After determining the amplitude A of the transmission signal 5 at the set frequency f, the microcontroller 20 uses the local oscillator 19 to set the frequency f associated with another transmission signal 5, wherein the amplitude A of the transmission signal 5 at the now set frequency f is determined according to the above explanation. The microcontroller 20 thus sets the frequency f associated with the respective transmission signal 5 to the mixers 18 one after the other by means of the local oscillator 19 and determines the corresponding amplitudes A one after the other.

As indicated in FIGS. 1 and 2, the transmitters 6 are spaced apart in the shown exemplary embodiments transversely to the first direction R1. The transmitters 6 generate a magnetic field as a transmission signal 5, as indicated in FIG. 1, which has a main axis along the first direction R1. Thus, the transmission signals 5 are applied transversely to the first direction R1 locally in the area of the associated transmitter 6. These transmission signals 5 are thus suitable for determining the relative position of the energy coils 3 to one another in the area near the transmitters 6, transverse to the first direction R1. The corresponding transmitters 6 are also referred to below as close-range transmitters 23. In the design exemplary embodiments shown, the close-range transmitters 23 are each designed as a flat coil 24, which is wound parallel to the first direction R1, so a winding axis (not shown) of the respective close-range transmitter 23 runs parallel to the first direction R1.

As can be seen from FIG. 2, the transmitting device 9 can have a further transmitter 6, that is, a fifth transmitter 6, 6e, which generates a magnetic field as a fifth transmission signal 5, 5e, which, as indicated in FIG. 2, has a main axis along the second direction R2 and thus along the X-direction. Thus, the sixth transmission signals 5, 5e of the sixth transmitter 6, 6e propagate transversely to the first direction R1 and can therefore also be received in the far range. The sixth transmitter 6, 6e is also referred to below as the long-range transmitter 27. In the exemplary embodiment shown, the remote transmitter 27 is wound around a winding axis (not shown) running along the second direction R2. The sixth transmission signal 5, 5e of the long-range transmitter 27 is received by the receiver 7 as described for the transmission signals of the close-range transmitter 23 and the local amplitude A of the sixth transmission signal 5, 5e of the long-range transmitter 27 is determined from the received signal 11. The frequency f of the long-range transmitter can be between 145.5 kHz and 147.5 kHz. If the system 1 has two or more transmitting devices 9, each with such a remote transmitter 27, the remote transmitters 27 of neighboring remote transmitters 27, preferably of remote transmitters 27 neighboring in the second direction R2, have different frequencies f.

With the locally determined amplitudes A of the respective transmitter 6, it is possible to determine the relative position of the energy coils 3 to one another by comparing the amplitudes A and thus to determine such position information. The position information can be provided via an interface 25 (see FIG. 6) of the microcontroller 15, 20 of an assistance device 103 of the mobile application 100, in particular of the motor vehicle 101, which is also indicated in FIG. 1. The assistance system 103 advantageously generates navigational instructions for the mobile application 100, as indicated by the arrows in FIG. 1, based on the received position information. The navigation instructions can also be generated by means of the positioning device 4 and made available to the assistance device 103 via the interface 24. The navigation instructions can be provided to a mobile application 100 guide for guiding the mobile application 100, for example via a human-machine interface (not shown). Likewise, the navigation instructions can be used for at least partially autonomous driving of the mobile application 100, in particular for at least partially autonomous driving of the motor vehicle 101. The purpose of the navigation instructions is to achieve improved positioning of the associated energy coils 3 to optimize energy transfer.

The implementation of the determination of the amplitudes and the generation of the position information is preferably carried out by means of a computer program product. The computer program product is preferably stored at least partially in the receiving device, in particular in the microcontroller 15, 20, on a non-volatile memory (not shown). The computer program product includes instructions which, when the computer program product is executed by the positioning device 4, in the illustrated exemplary embodiments by the receiving device 10, the positioning device 4, in the illustrated exemplary embodiments the receiving device 10, cause the amplitudes A to be determined and the position information to be generated.

1. A system for inductive energy transmission comprising:
at least one stationary induction charging device and at least one mobile induction charging device;
the at least one stationary induction charging device has including a stationary energy coil and the at least one-respective mobile induction charging device including a mobile energy coil;
the at least one stationary induction charging device configured to interact with one of the at least one mobile induction charging devices in a charging operation to transfer energy inductively via the stationary energy coil and the mobile energy coil;
a positioning device configured to detect a relative position of the stationary energy coil and the mobile energy coil belonging to the charging operation;
the positioning device including i) a transmitting device in one of the at least one stationary induction charging device and the at least one mobile induction charging device associated with the charging operation and ii) a receiving device in the other of the at least one stationary induction charging device and the at least one mobile induction charging device;
the transmitting device including at least two transmitters configured to, in operation, simultaneously emit a respective transmission signal with an associated predetermined frequency;
wherein the predetermined frequency associated with each of the at least two transmitters is different;
wherein the receiving device includes a receiver configured to output a superimposition of all received transmission signals as a time-dependent received signal; and
wherein the positioning device is configured to:
determine an associated amplitude for a respective received transmission signal from the time-dependent received signal; and
provide a position information item from a plurality of determined amplitudes, which represents the position information item representing a relative position of the stationary energy coil and the mobile energy coil to one another.

2. The system according to claim 1, wherein the positioning device is configured to demodulate the time-dependent received signal via IQ demodulation to determine at least one associated I-value and at least one associated Q-value for the respective received transmission signal from the time-dependent received signal and is configured to determine the associated amplitude for the respective received transmission signal from the at least one associated I-value and the at least one associated Q-value.

3. The system according to claim 1, wherein the positioning device is configured to determine the associated amplitude for the respective received transmission signal from the time-dependent received signal via Fourier transformation.

4. The system according to claim 1, wherein the positioning device is configured to determine the associated amplitude for the respective received transmission signal from the time-dependent received signal via a filter with a finite impulse response.

5. The system according to claim 1, wherein the receiving device is configured to:
sample the time-dependent received signal in succession at sampling rates corresponding to a multiple integer of the associated predetermined frequency of the respective received transmission signal to obtain a plurality of sampled values; and
determine the associated amplitude for the respective received transmission signal via the plurality of sampled values.

6. The system according to claim 5, wherein the sampling rates correspond to four times the associated predetermined frequency of the respective received transmission signal.

7. The system according to claim 5, wherein:
the receiving device, for sampling the time-dependent received signal and for determining the associated amplitude, includes an analog-digital converter connected downstream of the receiver and a digital signal processor connected to the analog-digital converter for data transfer; and
the receiving device is configured such that:
the digital signal processor sets the analog-digital converter to the sampling rates one after the other;
the analog-digital converter transmits the plurality of sampled values to the digital signal processor; and
the digital signal processor determines the associated amplitudes for each of the received transmission signals from the plurality of sampled values in succession.

8. The system according to claim 6, the receiving device is configured to:
determine an offset of the time-dependent received signal from two values, which are offset by 180°, of at least one of the sampling rates; and
account for the determined offset when determining the associated amplitude.

9. The system according to claim 2, wherein:
the receiving device includes:
two mixers connected downstream of the receiver;
an analog-digital converter connected downstream of the two mixers;
a local oscillator connected to the two mixers; and
a microcontroller connected to the analog-digital converter and to the local oscillator; and
the receiving device is configured such that:
the time-dependent received signal is transmitted to the two mixers;
the microcontroller adjusts the predetermined frequency of the respective received transmission signal at the two mixers in succession via the local oscillator such that the two mixers mix the time-dependent received signal offset by 90° to one another;
the microcontroller provides a mixed signal to the analog-digital converter:
the analog-digital converter provides a converted signal to the microcontroller; and
the microcontroller determines the associated amplitudes for each of the received transmission signals from the converted signal in succession.

10. The system according to claim 9, further comprising:
a first low-pass filter arranged between a first mixer of the two mixers and the analog-digital converter; and
a second low-pass filter arranged between a second mixer of the two mixers and the analog-digital converter.

11. The system according to claim 1, wherein the receiver includes two receiving coils wound offset to one another, the two receiving coils configured to receive the received transmission signals and to output the time-dependent received signal.

12. The system according to claim 1, wherein the receiving device includes a single receiver.

13. The system according to claim 1, wherein the predetermined frequency of each of the at least two transmitters is 110 kHz to 148.5 kHz.

14. The system according to claim 1, wherein:
in a charging mode, the stationary energy coil and the mobile energy coil are arranged in a first direction at a distance from and opposite each other; and
the at least two transmitters includes at least two close-range transmitters arranged spaced apart from one another transversely to the first direction, each of the at least two close-range transmitters configured to provide a magnetic field with a main axis extending along the first direction as the respective transmission signal.

15. The system according to claim 1, wherein the at least one stationary induction charging device has such a includes the transmitting device and the at least one mobile induction charging device includes the receiving device.

16. A computer program product, comprising instructions which, when the computer program product is executed by the positioning device of the system according to claim 1, cause the positioning device to determine the associated amplitude for the respective received transmission signal and provide the position information item.

17. The system according to claim 1, wherein the positioning device is configured to determine the associated amplitude for the respective received transmission signal from the time-dependent received signal via fast Fourier transformation.

18. The system according to claim 4, wherein the positioning device is configured to determine the associated amplitude for the respective received transmission signal from the time-dependent received signal via section-by-section correlation.

19. The system according to claim 4, wherein the positioning device is configured to determine the associated amplitude for the respective received transmission signal from the time-dependent received signal via convolution.

20. The system according to claim 7, wherein the sampling rates correspond to four times the associated predetermined frequency of the respective received transmission signal.
